(19) United States
(12) Patent Application Publication
(10) Pub. No.: US 2011/0089320 A1
(43) Pub. Date: Apr. 21, 2011

(54) DIRECT INJECTION NEBULIZER

(76) Inventors: Daniel R. Wiederin, Omaha, NE (US); Joel Handlos, Omaha, NE (US)

(21) Appl. No.: 12/581,577

(22) Filed: Oct. 19, 2009

(51) Int. Cl. H01J 49/26

(52) U.S. Cl. 250/288

(57) ABSTRACT

A direct injection nebulizing system includes a capillary and an injector. The capillary is insertable into the injector, and the injector is insertable into an injector holder. The injector includes an opening and a portion of the capillary extends beyond the opening of the injector.

### CROSS REFERENCE

The present application claims the benefit under 35 U.S.C. §119(e) of U.S. Provisional Application Ser. No. 60/196,529, filed Oct. 18, 2008. Application Ser. No. 60/196,529, filed Oct. 18, 2008 is herein incorporated by reference in its entirety.

### TECHNICAL FIELD

The present disclosure relates in general to lab instrumentation associated with mass spectrometry. More particularly, the disclosure relates to direct injection nebulizers for use in mass spectrometry.

### BACKGROUND

Sample solution nebulizer systems are used to introduce liquid samples into sample analysis systems. Sample solution nebulization is typically accomplished by known mechanical, pneumatic or ultrasonic means for instance, and sample analysis systems which can be used include Inductively Coupled Plasma (ICP), other plasma based systems, and mass spectrometers.

### SUMMARY

Accordingly, the present disclosure describes a direct injection nebulizing system including a capillary, and an injector, the capillary insertable into the injector, and the injector insertable into an injector holder. The injector includes an opening and a portion of the capillary extends beyond the opening of the injector and is constructed of a highly thermally conductive, opaque material.

It is to be understood that both the foregoing general description and the following detailed description are exemplary and explanatory only and are not restrictive of the invention claimed. The accompanying drawings, which are incorporated in and constitute a part of the specification, illustrate an embodiment of the invention and together with the general description, serve to explain the principles of the invention.

### DESCRIPTION OF THE DRAWINGS

The numerous objects and advantages of the present invention may be better understood by those skilled in the art by reference to the accompanying figures in which:

FIG. 1 is a side view illustrating a direct injection nebulizing system in accordance with an exemplary embodiment of the present disclosure;

FIG. 2 is an additional side view illustrating a direct injection nebulizing system in accordance with an exemplary embodiment of the present disclosure; and

FIG. 3 is an exploded isometric view illustrating a direct injection nebulizing system in accordance with an exemplary embodiment of the present disclosure.

### DETAILED DESCRIPTION

Reference will now be made in detail to the present embodiments of the invention, examples of which are illustrated below and in the accompanying drawings.

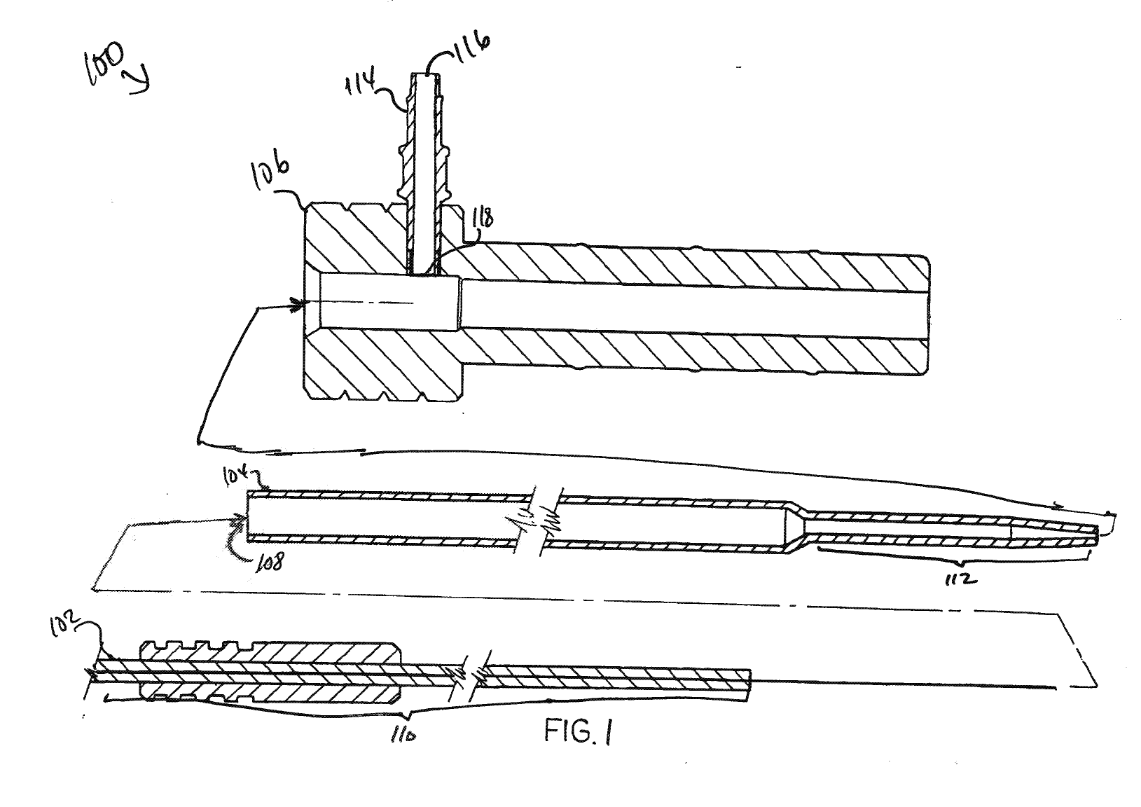

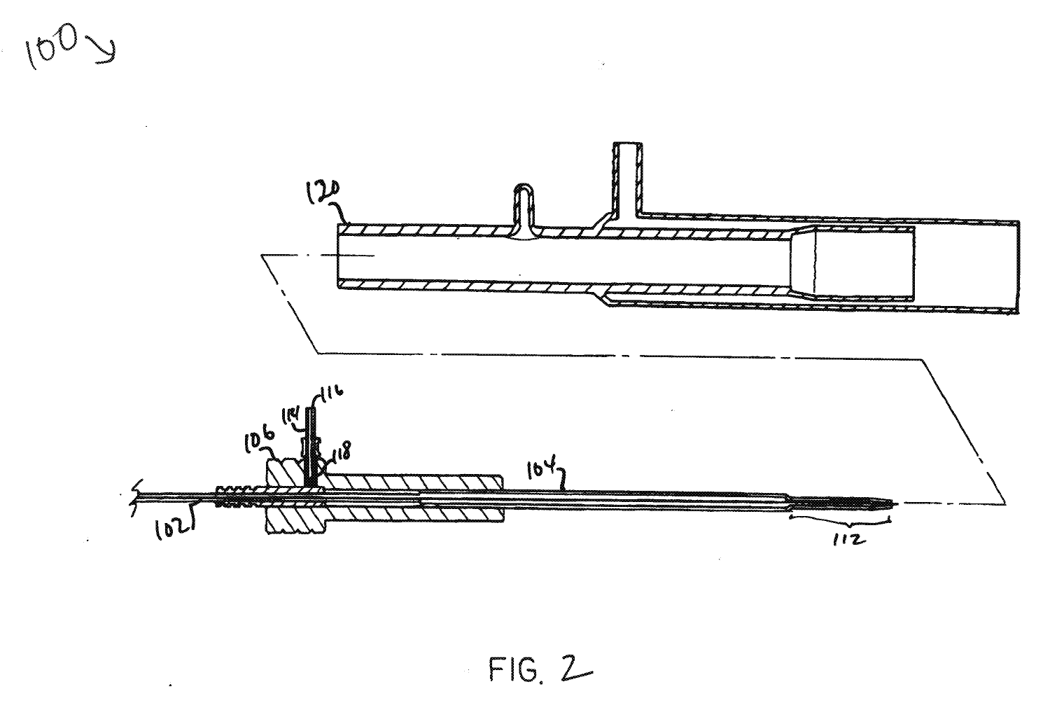

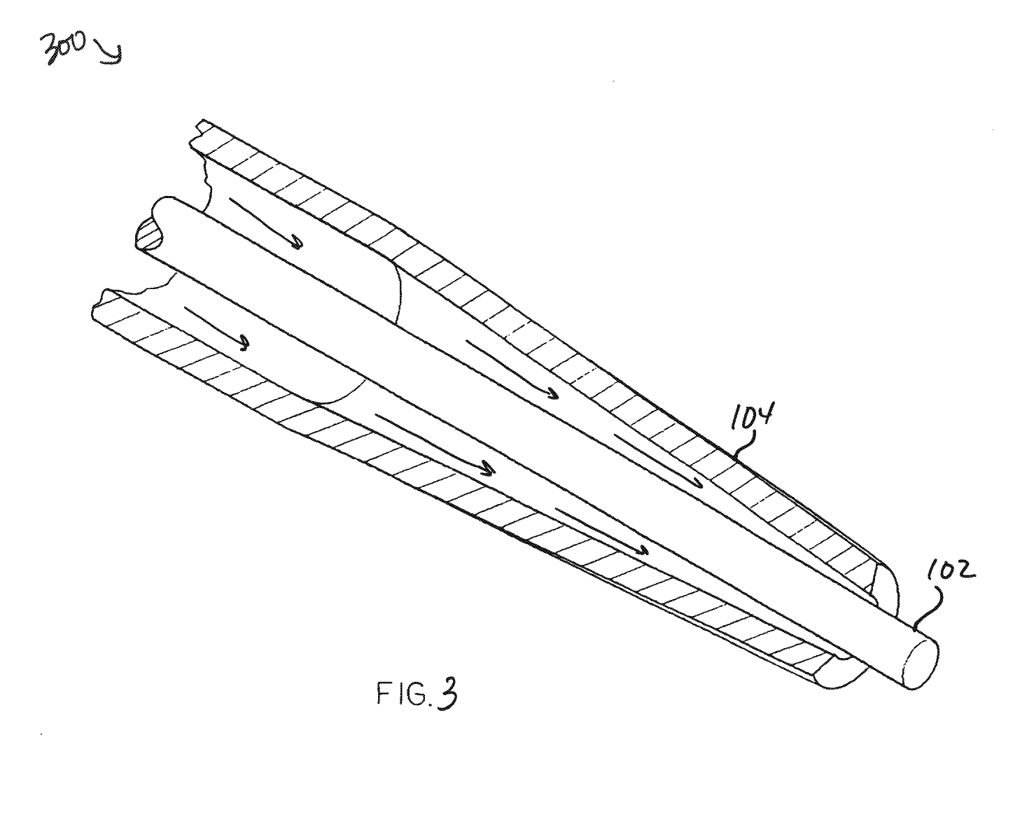

Referring to FIGS. 1-3, a direct injection nebulizing system 100 is depicted. FIGS. 1 and 2 are side views illustrating a direct injection nebulizing system 100 in accordance with an exemplary embodiment of the present disclosure. FIG. 3 is an exploded isometric view 300 illustrating a direct injection nebulizing system 100 in accordance with an exemplary embodiment of the present disclosure. System 100 includes a capillary 102 and an injector 104, the capillary 102 insertable into the injector 104, and the injector 104 insertable into an injector holder 106. The injector 104 includes an opening and a portion of the capillary 102 extends beyond the opening of the injector 104.

The capillary 102 may be a perfluoroalkoxy (PFA) sheathed quartz capillary having a diameter of at least 0.5 mm. The capillary 102 may include a sample input port and a sample output port for transporting sample solution. The capillary 102 may be a sample delivery tube system comprising, at a minimum, a sample delivery tube. Sample delivery tube may be composed of a flexible or rigid material. The capillary 102 may further include a substantially centrally located longitudinally oriented aperture. During use, the capillary 102 receives a sample solution inserted into a lower aspect (first end) thereof and forced to flow through said sample delivery tube to a capillary upper aspect (second end). The capillary 102 may further include, along at least a portion of its length, a temperature control element for use in controlling the temperature thereof and sample flowing therethrough during use. The capillary 102 may also include a protective sleeve 110 along at least a portion of its length, to prevent damage to the capillary.

The injector 104 may be an elongated tubular shell. The injector 104 may include a substantially centrally located longitudinally oriented aperture having an inner diameter greater than the outer diameter of the capillary 102. The injector 104 may include at least one end 112 tapering to a nozzle. The inner diameter of the tapered end 112 may be just greater than the outer diameter of the capillary 102, such that the capillary 102 may be inserted through the tapered end 112 of the injector 104 from inside the injector 104. Capillary may be inserted into the injector 104 via an injector first end 108. The injector 104 may be demountable and o-ring free. The injector 102 may be constructed from an opaque material blocking light and heat from the ICP from reaching the nebulizer capillary. In one embodiment, the injector 104 is constructed of a highly thermally conductive material (e.g., a thermally conductive platinum material).

The capillary 102 may be inserted or threaded into the centrally located longitudinally oriented hole in the injector 104 so that an upper aspect of the capillary 102 extends beyond an upper aspect (e.g., the nozzle 112) of the injector 104. The capillary 102 may removably secured within the injector 104 or an intermediate tube of a torch with which it is used. For instance, a flanged fitting may couple with the base of nebulizer body to directly attach the capillary 102 or an autosampler probe. In one embodiment, a connector may connect the injector and capillary. In one embodiment, connection means connecting the capillary and the injector is the upper aspect of the longitudinally oriented centrally located hole through the injector. The position of the upper aspect of the capillary 102 may be precisely adjustable longitudinally by longitudinal manipulation (manual or electronic) of the capillary 102 within the injector.

System 100 may further include an injector holder 106 having gas port 114 further including a gas input port 116 and a gas output port 118. A connector may connect the injector to the injector holder. In one embodiment, connectors may be screws having female screw threads. Gas may enter into and be forced to flow through the annular space formed between the outer surface of the capillary and the inner surface of the centrally located longitudinally oriented hole through the injector. In this manner, sample solution flow and gas flow may be substantially simultaneously ejected from the upper aspects of the capillary and the annular space between the outer surface of the capillary and the inner surface of the centrally located longitudinally oriented hole through the injector respectively, and interact with one another such that the sample solution is caused to be nebulized.

The capillary 102, injector 104 and injector holder 106 may be insertable into a torch 120 (e.g., quartz torch) for insertion into an ICP-MS or ICPAES instrument. In one embodiment, the system 100 may be insertable into an ICP torch 120 proximate to the high temperature plasma. The torch 120 may be a standard torch of the type used in inductively coupled plasma analysis of samples, in combination with the direct injection micro nebulizer system and may include one or more standard torch components. Typical components may include an outer tube which concentrically encompasses an intermediate tube, which intermediate tube concentrically encompasses a sample injector tube, each of which tubes is of a generally elongated shape and presents with a longitudinal dimension, at least one of outer, intermediate, sample and auxiliary sample flow ports, the outer port providing access to the annular space between the outer surface of the intermediate tube and the inner surface of the outer tube, the intermediate port providing access to the annular space between the outer surface of the sample injector tube and the inner surface of the intermediate tube; and the sample and sample auxiliary sample flow ports providing access to the space within the sample injector tube. The sample flow port may be located at the lower aspect of the standard torch, with lower aspect being defined as the vertically lower end of said standard torch as it is viewed in side elevation from a position perpendicularly removed therefrom, with the longitudinal dimensions of the various tubes projecting vertically upward, perpendicular to an underlying horizontal surface. As stated, they direct injection nebulizer system may be inserted into the space within the sample injector tube of the standard torch by way of the sample flow port at the lower aspect thereof thereby becoming concentrically encompassed by the sample injector tube, and the outer and intermediate flow ports may allow entrance of gas flows for protecting the tubes of the standard torch which the gas flows contact against the high temperatures and heat of a plasma which can be created inside the outer tube at the upper aspect of said standard torch, and to aid nebulized sample to flow thereto. The auxiliary sample gas flow port may allow entry of a gas flow into the annular space between the outer surface of the direct injection micro nebulizer system and the inner surface of the injector, which gas flow interacts with the nebulized sample flow to further nebulize the sample and to aid nebulized sample flow into the upper aspect of the standard torch wherein a plasma can be created for use in the analysis of the nebulized sample.

In one embodiment, the torch 120 may be a specially designed torch of the type used in inductively coupled plasma analysis of samples, in combination with the direct injection nebulizer system, which specially designed torch includes an outer tube which concentrically encompasses an intermediate tube, each of which tubes is of a generally elongated shape presenting with a longitudinal dimension, at least one outer, intermediate and/or sample flow port. The outer port may provide access to the annular space between the outer surface of the intermediate tube and the inner surface of the outer tube, and the intermediate and sample flow ports may provide access to the space within the intermediate tube. The sample flow port may be located at the lower aspect of the specially designed torch, with lower aspect being defined as the vertically lower end of said specially designed torch as it is viewed in side elevation from a position perpendicularly removed therefrom, with the longitudinal dimensions of the various tubes projecting vertically upward, perpendicular to an underlying horizontal surface. The direct injection nebulizer system may be inserted into the space within the intermediate tube of the specially designed torch by way of the sample flow port therein thereby becoming concentrically encompassed by the intermediate tube. The outer port allows entrance of a gas flow which serve to protect the tubes of the specially designed torch upon contact of the torch with the high temperatures and heat of a plasma which can be created inside the outer tube at the upper aspect of said specially designed torch. The gas flow entering to the intermediate port interacts with the nebulized sample flow created by interaction with the sample solution and gas flows entering the lower aspect of the capillary and the connection means of the injector of the direct injection nebulizer system respectively, to further nebulize the sample and to aid its flow into the upper aspect of the specially designed torch wherein a plasma can be created for use in the analysis of the nebulized sample.

In one embodiment, a system includes a platinum direct injection nebulizer (DIN), continuously flowing gas displacement pump (C-GDP), injection valve, and an autosampler interfaced to an ICPMS. System may be fully integrated with ICP and autosampler software and provide up to 100% nebulization efficiency, equal response for all analyte species, and syringe pump sample loading.

The system 100 provides fast washout for memory-prone elements, high stability, uniform analyte response, and full automation. The system 100 keeps the nebulizer capillary cooler. Overheating has causes the solvent to evaporate prior to nebulization, leaving salt deposits inside the nebulizer capillary which causes instability. Thus, a cooler nebulizer capillary may prevent salt deposition, minimize degradation of polymeric HF-resistant sample capillaries, improve long-term stability. The nebulizer nebulizes a liquid sample directly into an inductively coupled plasma atomic emission spectrometer (ICPAES) or inductively coupled plasma mass spectrometer (ICPMS) via the injector nozzle constructed from a thermally conductive material. Nebulized sample droplets may be transported to a location of a sample analysis system by way of a connection means (not shown).

It is believed that the present invention and many of its attendant advantages will be understood by the foregoing description. It is also believed that it will be apparent that various changes may be made in size, materials, shape, form, function, manner of operation, assembly and use of the components thereof without departing from the scope and spirit of the invention or without sacrificing all of its material advantages. The form herein before described being merely an explanatory embodiment thereof. Further, it is contemplated that the specific order or hierarchy of steps in the method can be rearranged while remaining within the scope and spirit of the present invention. It is the intention of the following claims to encompass and include such changes.

What is claimed:

1. A direct injection nebulizer system comprising:
a capillary of a generally elongated shape, the capillary tapering from a first end to a second end; and
an injector, further including a substantially centrally located longitudinally oriented aperture, the capillary being insertable into the injector via the aperture and a portion of the capillary extending beyond a front opening of the aperture, the injector formed from a highly conductive thermal material.

2. The direct injection nebulizer system of claim 1, further including:
an injector holder.

3. The direct injection nebulizer system of claim 1, wherein the capillary includes a fluoropolymer resin sheath.

4. The direct injection nebulizer system of claim 3, wherein the capillary is a perfluoroalkoxy (PFA) sheathed quartz capillary having a diameter of at least 0.5 mm.

5. The direct injection nebulizer system of claim 1, wherein the capillary further includes:
a sample input port and a sample output port for transporting a sample solution.

6. The direct injection nebulizer system of claim 1, wherein the capillary further includes:
a protective sleeve along at least a portion of its length.

7. The direct injection nebulizer system of claim 1, wherein the substantially centrally located longitudinally oriented aperture of the injector has an inner diameter greater than an outer diameter of the capillary.

8. The direct injection nebulizer system of claim 1, wherein the injector includes at least one end tapering to a nozzle.

9. The direct injection nebulizer system of claim 8, wherein the inner diameter of the tapered end is just greater than or equal to the outer diameter of the capillary.

10. The direct injection nebulizer system of claim 1, wherein the injector is constructed from an opaque material.

11. The direct injection nebulizer system of claim 1, wherein the injector is constructed from a thermally conductive platinum material.

12. The direct injection nebulizer system of claim 1, wherein the position of an upper aspect of the capillary is precisely adjustable longitudinally by longitudinal manipulation of the capillary within the injector.

13. The direct injection nebulizer system of claim 1, further including an injector holder having gas port further including a gas input port and a gas output port.

14. The direct injection nebulizer system of claim 13, wherein the injector is insertable through and connected to the injector holder.

15. The direct injection nebulizer system of claim 1, further including a torch, the capillary, injector and the injector holder insertable into the torch for insertion into an ICP-MS or ICPAES instrument.

16. The direct injection nebulizer system of claim 15, wherein the capillary, the injector, and the injector holder are insertable into the torch proximate to a high temperature plasma region of an ICP-MS or ICPAES instrument.
